(19) United States
(12) Patent Application Publication
(10) Pub. No.: US 2015/0263849 A1
(43) Pub. Date: Sep. 17, 2015

(54) PHASE ADJUSTMENT CIRCUIT AND METHOD, AND DATA TRANSMISSION APPARATUS AND SYSTEM

(71) Applicant: FUJITSU LIMITED, Kawasaki-shi (JP)

(72) Inventor: Yuji Terao, Kawasaki (JP)

(21) Appl. No.: 14/617,968

(22) Filed: Feb. 10, 2015

(30) Foreign Application Priority Data
Mar. 13, 2014 (JP) 2014-050387

(51) Int. Cl. H04L 7/00; H04L 7/033

(52) U.S. Cl. CPC H04L 7/0016; H04L 7/0331

(57) ABSTRACT

A phase adjustment circuit includes a comparator circuit and a synchronization circuit. The comparator circuit compares, with respect to each of multiple lanes, a common reference clock signal fed to each lane with first and second transmission clock signals each of which is in antiphase and is generated in each lane. The synchronization circuit synchronizes, with respect to each lane, data distributed to each lane with one of the first and second transmission clock signals, wherein a phase difference between the one of the first and second transmission clock signals and the reference clock signal is smaller than a phase difference between the other of the first and second transmission clock signals and the reference clock signal.

### CROSS-REFERENCE TO RELATED APPLICATION

This application is based upon and claims the benefit of priority of the prior Japanese Patent Application No. 2014-050387, filed on Mar. 13, 2014, the entire contents of which are incorporated herein by reference.

### FIELD

A certain aspect of the embodiments discussed herein is related to phase adjustment circuits and methods, and data transmission apparatuses and systems.

### BACKGROUND

As a technique that accommodates an increase in the rate of data transmission, multi-lane transmission that transmits data through a link composed of multiple transmission paths (lanes) is known. According to the multi-lane transmission, parallel data divided by the number of lanes are converted into serial data, and the serial data transmitted to the lanes from a transmitting end are synthesized at a receiving end. At the receiving end, the serial data of the lanes are synthesized after removal of a difference in transmission time between the serial data of lanes (a skew between lanes). When the skew between lanes is too large, however, the skew is not completely removed at the receiving end, so that the phase of a transmission clock signal to carry the serial data may be adjusted at the transmitting end so as to be the same for all the lanes.

For example, International Publication Pamphlet No. WO2010/097846 illustrates a technique for adjusting the phase of a clock signal.

### SUMMARY

According to an aspect of the embodiments, a phase adjustment circuit includes a comparator circuit and a synchronization circuit. The comparator circuit compares, with respect to each of multiple lanes, a common reference clock signal fed to each lane with first and second transmission clock signals each of which is in antiphase and is generated in each lane. The synchronization circuit synchronizes, with respect to each lane, data distributed to each lane with one of the first and second transmission clock signals, wherein a phase difference between the one of the first and second transmission clock signals and the reference clock signal is smaller than a phase difference between the other of the first and second transmission clock signals and the reference clock signal.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a schematic diagram for illustrating a phase adjustment method executed by a phase adjustment circuit;

FIG. 2 is a diagram illustrating a configuration of a data transmission system;

FIG. 3 is a diagram illustrating a configuration of the phase adjustment circuit;

FIG. 4 is a diagram illustrating a configuration of a comparator circuit and a configuration of a synchronization circuit;

FIG. 5 is a timing chart of signals illustrating an example of the phase adjustment method;

FIG. 6 is a timing chart of signals illustrating an example of the phase adjustment method;

FIG. 7 is a timing chart of signals illustrating an example of the phase adjustment method;

FIG. 8 is a flowchart illustrating an example of the phase adjustment method;

FIG. 9 is a diagram illustrating a configuration of an example of the phase adjustment circuit; and

FIG. 10 is a diagram illustrating a configuration of an example of the phase adjustment circuit.

### DESCRIPTION OF EMBODIMENTS

As described above, according to the multi-lane transmission, the phase of a transmission clock signal may be adjusted so as to be the same for all lanes. Therefore, for example, by transferring the phase information of a clock signal of a lane to an adjacent lane, it is possible to force the phase of the adjacent lane to which the phase information is transferred to match the phase of the lane from which the phase information is transferred.

According to this method, however, when the distance between lanes increases, a delay before the phase information is transferred to the adjacent lane may be longer than the clock period of the phase information. In this case, the phase information is not properly transferred, so that it is difficult to reduce the skew between lanes.

According to an aspect of the embodiments, a phase adjustment circuit and method and a data transmission apparatus and system capable of reducing the skew between lanes are provided.

Thus, according to an aspect of the embodiments, it is possible to reduce the skew between lanes.

Preferred embodiments of the present invention will be explained with reference to accompanying drawings.

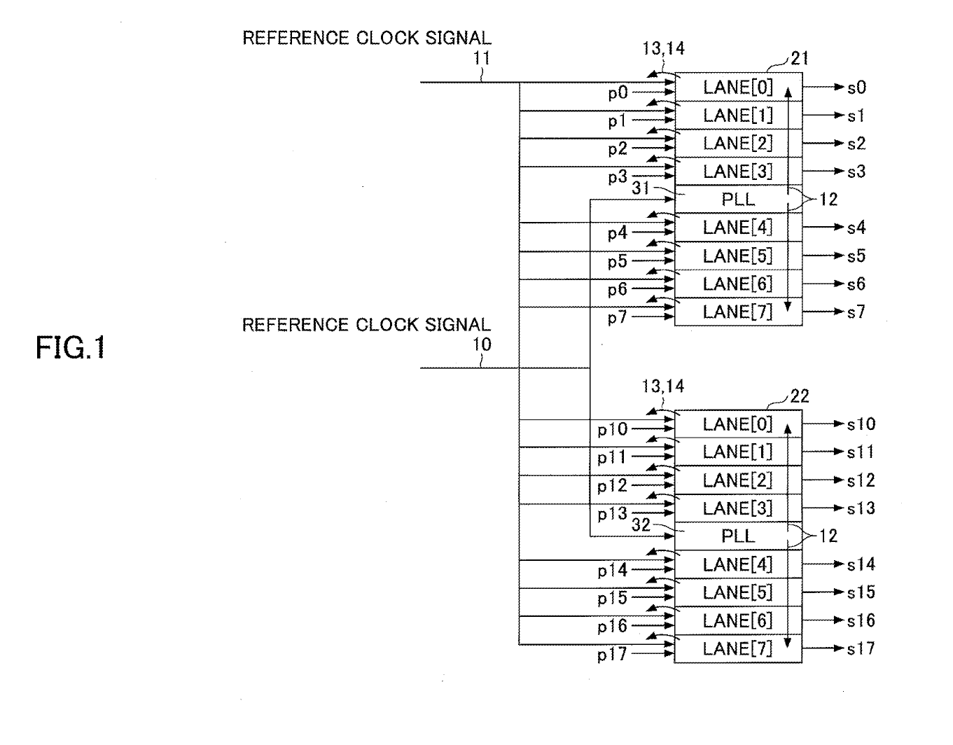

FIG. 1 is a schematic diagram for illustrating a phase adjustment method executed by a phase adjustment circuit according to an embodiment. Referring to FIG. 1, a phase adjustment circuit 21 is an example of a phase adjustment circuit that has the function of comparing a common reference clock 11 supplied simultaneously to a lane[0], a lane[1], a lane[2], a lane[3], a lane[4], a lane[5], a lane[6] and a lane[7] and two transmission (TX) clock signals 13 and 14 generated in each of the lane[0] through the lane[7] with respect to each of the lane[0] through the lane[7] (that is, lane by lane). Hereinafter, a lane[*] (where * is an integer) is expressed as “lane L*”.

The lane is a transmission path that transmits data and is a circuit that includes a serializer provided at a transmitting end and a deserializer provided at a receiving end. The serializer is a circuit that includes a parallel data input part and a serial data output part. The serializer converts parallel data input to the parallel data input part into serial data, and output the serial data from the serial data output part. The deserializer is a circuit that includes a serial data input part and a parallel data output part. The deserializer converts serial data input to the serial data input part into parallel data, and outputs the parallel data from the parallel data output part.

FIG. 1 illustrates the transmitting-end serializers of the lanes L0 through L7 in a block diagram. The number of lanes is not limited to seven as illustrated in FIG. 1 as long as the number is two or more.

The TX clock signals 13 and 14 are examples of two transmission clock signals that are in antiphase, and are signals reverse in phase to each other. For example, assuming that the TX clock signal 13 is a positive-phase clock signal, the TX clock signal 14 is a reverse-phase clock signal whose phase is 180° different from the phase of the TX clock signal 13. The TX clock signals 13 and 14 are generated in each of the lanes L0 through L7 based on a common base clock signal 12 supplied from a phase locked loop (PLL) 31 in the phase adjustment circuit 21 to each of the lanes L0 through L7.

The base clock signal 12 is an example of a clock signal for generating the TX clock signals 13 and 14. The PLL 31 is an example of a phase locked loop that generates the base clock signal 12 synchronized with a reference clock signal 10 by multiplying the reference clock signal 10 by n (where n is an integer) and supplies the generated base clock signal 12 to each of the lanes L0 through L7.

The PLL 31 generates, for example, the base clock signal 12 having twice the frequency of the reference clock signal 11. Each of the lanes L0 through L7 generates a clock signal having the same frequency as the base clock signal 12 as the TX clock signal 13 and generates the TX clock signal 14 by inverting the base clock signal 12.

The phase adjustment circuit 21 compares the common reference clock signal 11 fed to each of the lanes L0 through L7 and the two TX clock signals 13 and 14 generated in each of the lanes L0 through L7 with respect to each of the lanes L0 through L7 (lane by lane). For example, the phase adjustment circuit 21 compares the reference clock signal 11 supplied to the lane L0 and the TX clock signals 13 and 14 generated in the lane L0 based on the base clock signal 12 supplied to the lane L0. Likewise, the phase adjustment circuit 21 compares the reference clock signal 11 supplied to the lane L1 and the TX clock signals 13 and 14 generated in the lane L1 based on the base clock signal 12 supplied to the lane L1. The phase adjustment circuit 21 performs comparison in the same manner with respect to the other lanes.

The phase adjustment circuit 21 compares the reference clock signal 11 and the TX clock signal 13 and compares the reference clock signal 11 and the TX clock signal 14 lane by lane, and selects one of the TX clock signals 13 and 14 with respect to each of the lanes L0 through L7, where the one of the TX clock signals 13 and 14 has a smaller phase difference from the reference clock signal 11 than the other of the TX clock signals 13 and 14. Then, the phase adjustment circuit 21 synchronizes parallel data p0, p1, p2, p3, p4, p5, p6 and p7 assigned to the lanes L0, L1, L2, L3, L4, L5, L6 and L7, respectively, with the one of the TX clock signals 13 and 14 having the smaller phase difference from the reference clock signal 11 lane by lane.

For example, the phase adjustment circuit 21 converts the parallel data p0 assigned to the lane L0 into serial data s0 synchronized with one of the TX clock signals 13 and 14 generated in the lane L0 which one has the smaller phase difference from the reference clock signal 11 fed to the lane L0, and transmits the serial data s0 to the lane L0. Likewise, the phase adjustment circuit 21 converts the parallel data p1 assigned to the lane L1 into serial data s1 synchronized with one of the TX clock signals 13 and 14 generated in the lane L1 which one has the smaller phase difference from the reference clock signal 11 fed to the lane L1, and transmits the serial data s1 to the lane L1. The phase adjustment circuit 21 executes the same synchronization, conversion and transmission process with respect to the other lanes.

Thus, according to this embodiment, the TX clock signals 13 and 14 are generated in each of the lanes L0 through L7. Therefore, for example, even when the delay time before the arrival of the base clock signal 12 at the lanes from the PLL 31 differs between lanes, it is possible to accurately compare the phase of the reference clock signal 11 and the phases of the TX clock signals 13 and 14 in each of the lanes L0 through L7. Furthermore, according to this embodiment, the common reference clock signal 11 fed to each of the lane L1 through L7 and the two TX clock signals 13 and 14 generated in each of the lanes L1 through L7 are compared lane by lane. Therefore, it is possible to prevent the comparison result of a lane from interfering with the comparison result of another lane. Furthermore, according to the embodiment, it is possible in each lane to independently select and determine a TX clock signal with which to synchronize data assigned to the lane based on the common reference clock signal 11 fed to each lane.

Accordingly, it is possible to reduce variations in transmission time among the serial data s0 through s7 (skews among the lanes L0 through L7) by synchronizing, lane by lane, the parallel data p0 through p7 assigned to the lanes L0 through L7, respectively, with TX clock signals independently selected and determined lane by lane based on the reference clock signal 11 common to the lanes L0 through L7. Furthermore, for example, because the TX clock signals 13 and 14 have twice the frequency of the reference clock signal 11, it is possible to reduce skews among the lanes L0 through L7 to half the period of the TX clock signals 13 and 14. As the data rate increases, the skew reduction effect increases. Furthermore, the operation of synchronizing data with the TX clock signal is closed in each lane. Therefore, even when malfunction occurs in any of the lanes L0 through L7, it is possible to stop operation on a lane-by-lane basis.

Furthermore, as illustrated in FIG. 1, the reference clock signal 11 may also be fed to the lanes L0 through L7 corresponding to a phase adjustment circuit 22 other than the phase adjustment circuit 21. The phase adjustment circuit 22 has the same functions as the phase adjustment circuit 21. That is, the phase adjustment circuit 22 compares the common reference clock signal 11 fed to each of the lanes L0 through L7 and the two TX clock signals 13 and 14 that are in antiphase and generated in each of the lanes L0 through L7 with respect to each of the lanes L0 through L7 (lane by lane), and synchronizes data assigned to each of the lanes L0 through L7 with one of the TX clock signals 13 and 14 that has the smaller phase difference from the reference clock signal 11 with respect to each of the lanes L0 through L7. The phase adjustment circuit 22 converts parallel data p10, p11, p12, p13, p14, p15, p16 and p17 assigned to the lanes L0, L1, L2, L3, L4, L5, L6 and L7 into serial data s10, s11, s12, s13, s14, s15, s16 and s17, respectively, and transmits the serial data s10 through s17 to the lanes L0 through L7, respectively.

Even when the phase adjustment circuits 21 and 22 are distant from each other, it is possible to reduce skews between the lanes L0 through L7 corresponding to the phase adjustment circuit 21 and the lanes L0 through L7 corresponding to the phase adjustment circuit 22 when the phase adjustment circuits 21 and 22 have the above-described same functions.

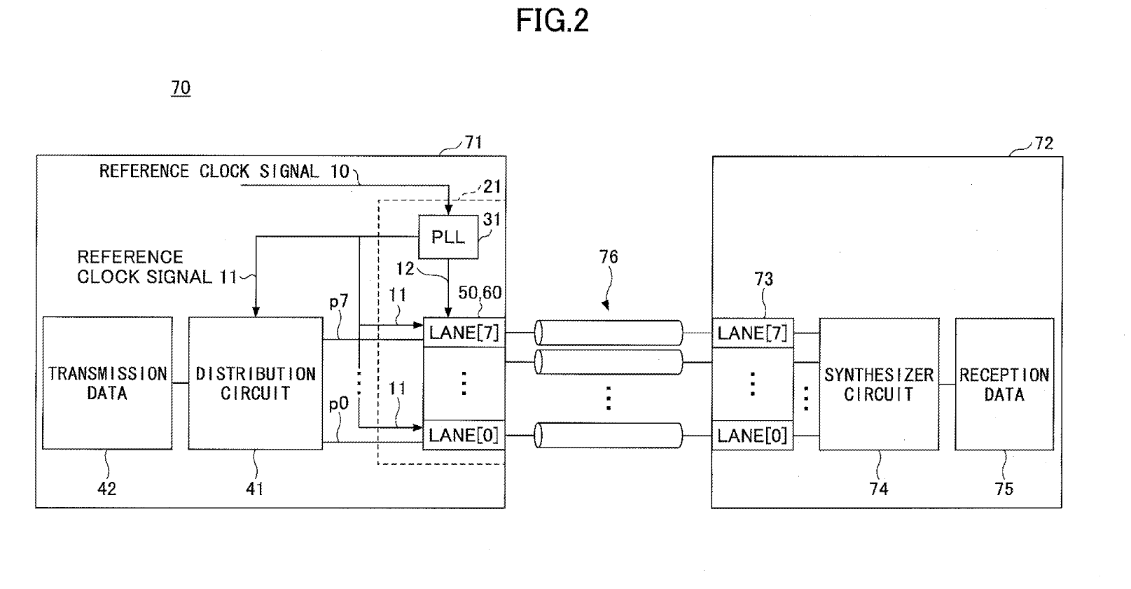

FIG. 2 is a diagram illustrating a configuration of a data transmission system 70. The data transmission system 70 includes a transmitter 71, a receiver 72, and a link 76 through which data transmitted and received between the transmitter 71 and the receiver 72 are communicated. Each of the transmitter 71 and the receiver 72 is formed of, for example, a semiconductor integrated circuit (whose specific examples include large-scale integration [LSI] circuits).

The transmitter 71 is an example of a data transmission apparatus that includes a distribution circuit 41 and the phase adjustment circuit 21.

The distribution circuit 41 is an example of a circuit that divides predetermined transmission data (data to be transmitted) 42 into the parallel data p0 through p7 that are synchronized with the reference clock signal 11 and delivers the parallel data p0 through p7 to the lanes L0 through L7, respectively.

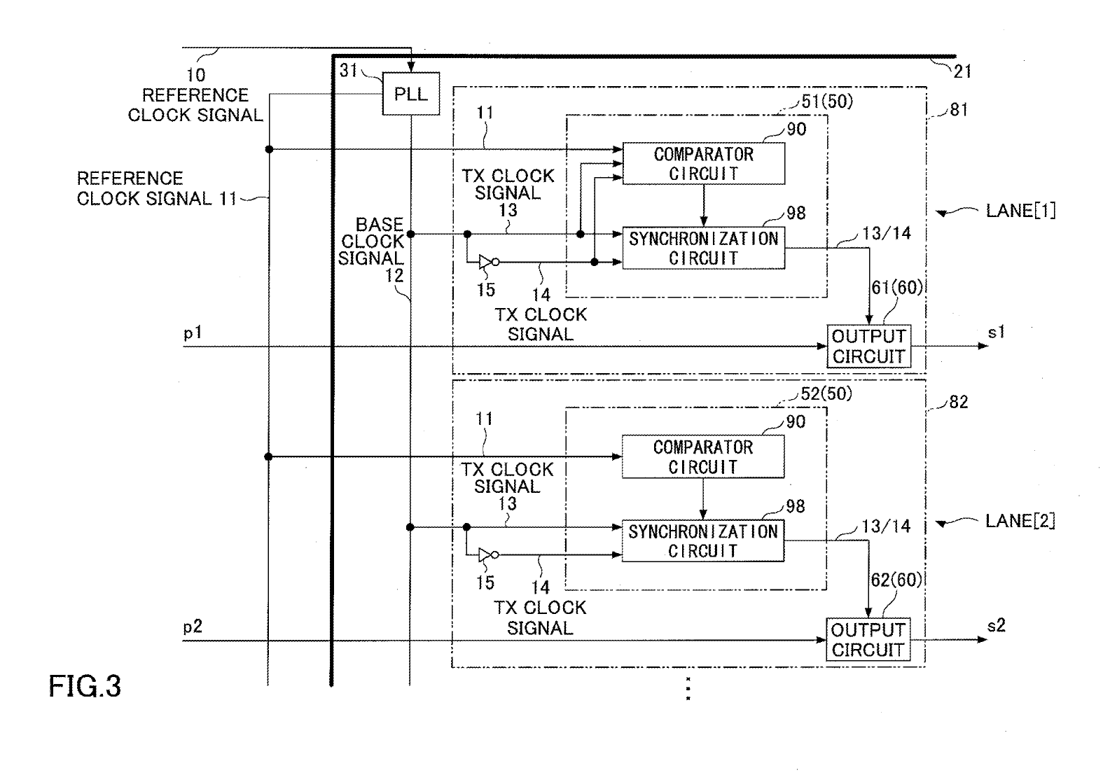

The reference clock signal 11 is fed to the distribution circuit 41 and the lanes L0 through L7 from the PLL 31 inside the phase adjustment circuit 31 in order to synchronize the parallel data p0 through p7 with clock signals inside the phase adjustment circuit 21. The reference clock signal 11 is fed to a comparator circuit 90 (FIG. 3) provided in each of the lanes L0 through L7 inside the phase adjustment circuit 21 via paths outside the phase adjustment circuit 21. When the phase adjustment circuit 21 is, for example, a single circuit macro (circuit block), it is possible to easily control skews generated because of a difference between paths of the reference clock signal 11 to the lanes L0 through L7 as a result of the reference clock signal 11 going through paths outside the phase adjustment circuit 21. It is relatively difficult to control a difference between paths to lanes by adjusting circuits inside the circuit macro. Therefore, for example, by changing wire length or inserting a delay circuit such as a buffer with respect to wires outside the circuit macro, it is possible to easily control skews between the reference clock signals 11 fed to the lanes L0 through L7.

The phase adjustment circuit 21 includes a skew control circuit 50 and a transmission circuit 60.

The skew control circuit 50 is an example of a selector circuit that compares the common reference clock signal 11 fed to each of the lanes L0 through L7 and the two TX clock signals 13 and 14 that are in antiphase and generated in each of the lanes L0 through L7 with respect to each of the lanes L0 through L7 (lane by lane), and selects one of the TX clock signals 13 and 14 that has the smaller phase difference from the reference clock signal 11 with respect to each of the lanes L0 through L7. The transmission circuit 60 is an example of a circuit that transmits the parallel data p0 through p7 distributed to the lanes L0 through L7, respectively, by the distribution circuit 41, based on the TX clock signal selected lane by lane by the skew control circuit 50.

The receiver 72 is an example of a receiver that includes a reception circuit 73 and a synthesizer circuit 74. The reception circuit 73 is an example of a circuit that receives serial data transmitted by the transmission circuit 60 through the link 76. The synthesizer circuit 74 synthesizes the serial data of the lanes L0 through L7 received by the reception circuit 73 into reception data (received data) 75 and outputs the reception data 75. Because skews among the lanes L0 through L7 are reduced by the phase adjustment circuit 21, it is possible for the synthesizer circuit 74 to synthesize the serial data of the lanes L0 through L7 received by the reception circuit 73.

FIG. 3 is a diagram illustrating a configuration of the phase adjustment circuit 21. In FIG. 3, the lanes L1 and L2 are illustrated by way of example, and other lanes are omitted because of having the same configuration as the lanes L1 and L2. The phase adjustment circuit 21 includes the PLL 31 and serializers one provided for each lane. FIG. 3 illustrates a serializer 81 for the lane L1 and a serializer 82 for the lane L2. The serializer 81 converts the parallel data p1 assigned to the lane L1 into the serial data s1 synchronized with the TX clock signal selected by the skew control circuit 50, and outputs the serial data s1. The serializer 82 converts the parallel data p2 assigned to the lane L2 into the serial data s2 synchronized with the TX clock signal selected by the skew control circuit 50, and outputs the serial data s2.

The skew control circuit 50 includes, for example, for each lane, an adjustment circuit that adjusts the phase of the data of the lane. By way of example, FIG. 3 illustrates a first adjustment circuit 51 that adjusts the phase of the data of the lane L1 and a second adjustment circuit 52 that adjusts the phase of the data of the lane L2.

The transmission circuit 60 includes, for example, for each lane, an output circuit that transmits serial data synchronized with the TX clock signal selected by the skew control circuit 50 to the lane. By way of example, FIG. 3 illustrates a first output circuit 61 that transmits the serial data of the lane L1 to the lane L1 and a second output circuit 62 that transmits the serial data of the lane L2 to the lane L2.

The first adjustment circuit 51 includes a comparator circuit 90 and a synchronization circuit 98. The comparator circuit 90 is an example of a comparator circuit that compares the phase of the common reference clock 11 fed to each lane and the phases of the two TX clock signals 13 and 14 generated in each lane with respect to each lane. The synchronization circuit 98 is an example of a synchronization circuit that synchronizes data assigned to each lane with one of the TX clock signals 13 and 14 that has the smaller phase difference from the reference clock signal 11 with respect to each lane. The base clock signal 12 fed to each lane is inverted in an inverter circuit 15 provided in each lane, so that the TX clock signals 13 and 14 are generated in each lane.

The first adjustment circuit 51 and the second adjustment circuit 52 may have the same configuration. Therefore, the description of the first adjustment circuit 51 is used for the description of the second adjustment circuit 52.

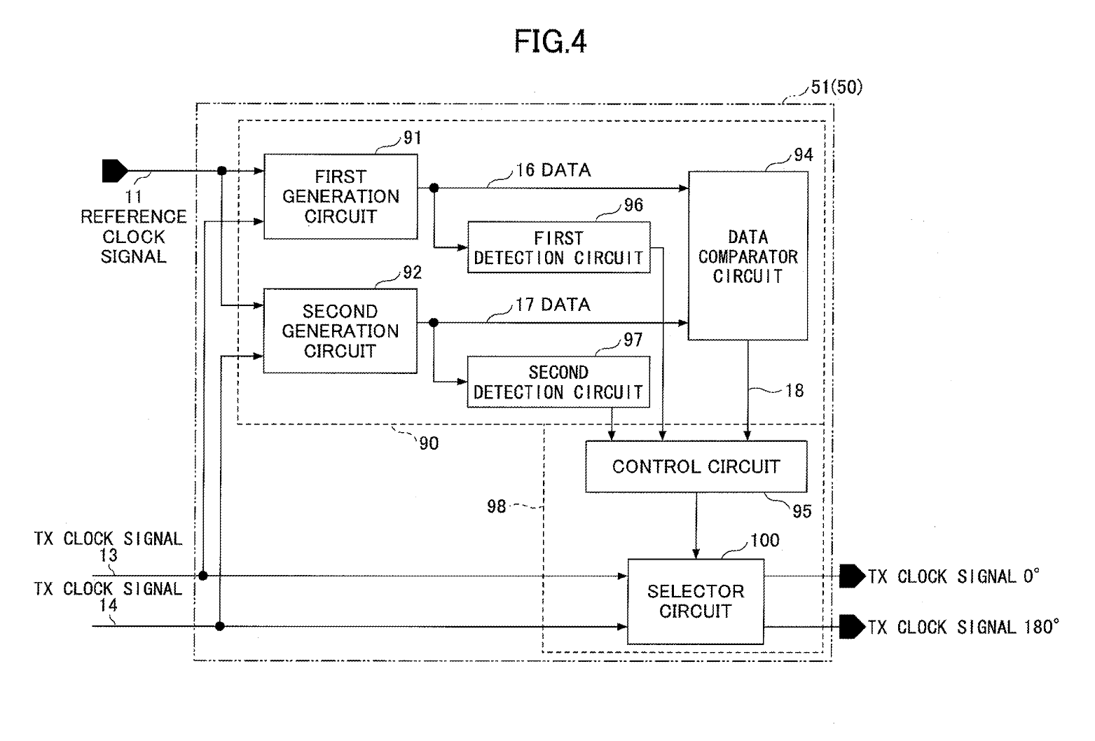

FIG. 4 is a diagram illustrating a configuration of the first adjustment circuit 51 in the skew control circuit 50. The first adjustment circuit 51 includes the comparator circuit 90 and the synchronization circuit 98. The comparator circuit 90 includes a first generation circuit 91 that generates data 16, a second generation circuit 91 that generates data 17, a first detection circuit 96 that detects the duty ratio of the data 16, a second detection circuit 97 that detects the duty ratio of the data 17, and a data comparator circuit 94. The synchronization circuit 98 includes a control circuit 95 and a selector circuit 100.

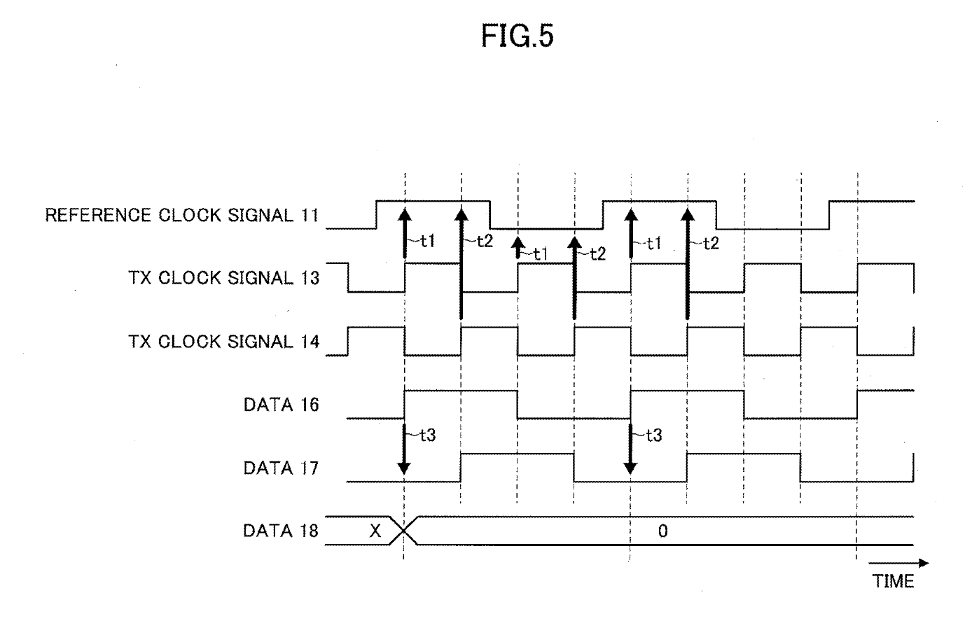

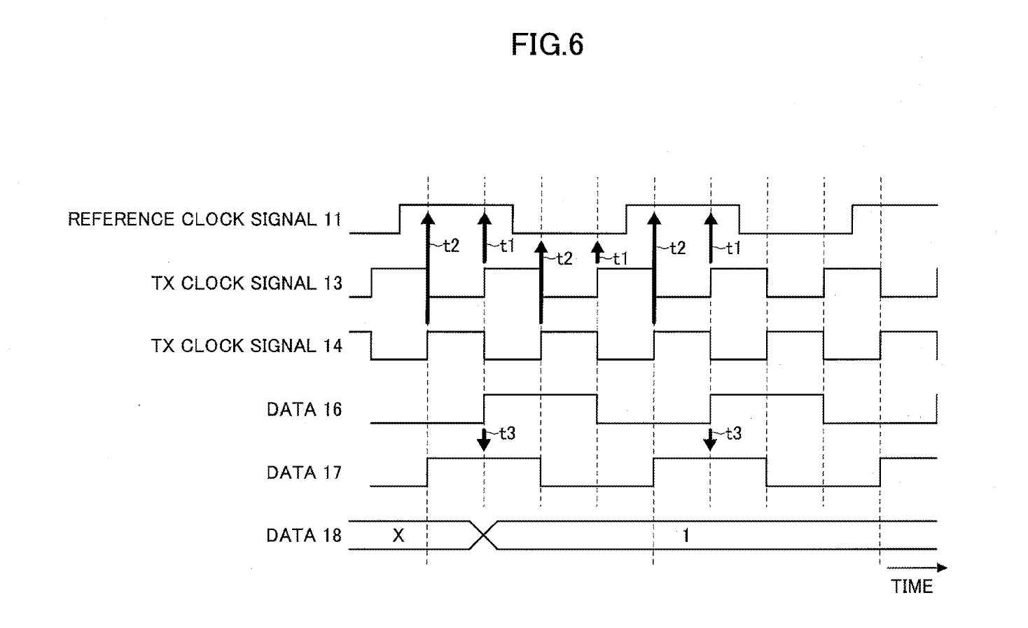

FIG. 5 is a timing chart of signals illustrating a phase adjustment operation of the first adjustment circuit 51 in the case where the rising edge of the TX clock signal 13 is closer to the rising edge of the reference clock signal 11 than is the rising edge of the TX clock signal 14. FIG. 6 is a timing chart of signals illustrating a phase adjustment operation of the first adjustment circuit 51 in the case where the rising edge of the TX clock signal 14 is closer to the rising edge of the reference clock signal 11 than is the rising edge of the TX clock signal 13.

Next, a description is given, with reference to FIG. 4, of each timing chart.

The first adjustment circuit 51 creates the data 16 and the data 17 by detecting edges of the reference clock 11 using the TX clock signal 13 and the TX clock signal 14 that is in antiphase with the TX clock signal 13. The first adjustment circuit 51 samples the reference clock signal 11 so that the data 16 and the data 17 each have a duty ratio of 50%.

For example, the first generation circuit 91 samples the reference clock signal 11 at rising edges of the TX clock signal 13 at times t1. Likewise, the second generation circuit 92 samples the reference clock signal 11 at rising edges of the TX clock signal 14 at times t2. The first and second generation circuits 91 and 92 each include, for example, multiple flip-flops arranged in series and connected in a daisy-chain layout, and create the data 16 and the data 17 of a duty ratio of 50% that repeat “0” (low level) and “1” (high level) of a predetermined width by performing a logical operation on the output result of the flip-flop of each stage.

The data comparator circuit 94 samples the data 17 using the rising edge of the data 16 as a trigger. Because the reference clock signal 11 is sampled using the data 16 and 17 having the same frequency, the data 17 always present the same logical value at the rising edge of the data 16. Therefore, in the case where the rising edge of the TX clock signal 13 immediately follows the rising edge of the reference clock signal 11, the data 17 are always logical “0” at the rising edge of the data 16 (FIG. 5). On the other hand, in the case where the rising edge of the TX clock signal 14 immediately follows the rising edge of the reference clock signal 11, the data 17 are always logical “1” at the rising edge of the data 16 (FIG. 6).

Accordingly, the data comparator circuit 94 outputs data 18 of logical “0” when the rising edge of the TX clock signal 13 is closer to the rising edge of the reference clock signal 11 than is the rising edge of the TX clock signal 14, and outputs the data 18 of logical “1” when the rising edge of the TX clock signal 14 is closer to the rising edge of the reference clock signal 11 than is the rising edge of the TX clock signal 13.

The control circuit 95 controls the selector circuit 100 in accordance with the logic of the data 18 so that one of the TX clock signals 13 and 14 that has the smaller phase difference from the reference clock signal 11 is selected as a transmission clock signal of a phase of 0° with which to synchronize data assigned to each lane. Likewise, the control circuit 95 controls the selector circuit 100 in accordance with the logic of the data 18 so that one of the TX clock signals 13 and 14 that has the larger phase difference from the reference clock signal 11 is selected as a transmission clock signal of a phase of 180° with which not to synchronize data assigned to each lane.

For example, the control circuit 95 controls the selector circuit 100 so that the TX clock signal 13 is selected as a transmission clock signal of a phase of 0° with which to synchronize data assigned to each lane when the logic of the data 18 is “0,” and controls the selector circuit 100 so that the TX clock signal 14 is selected as a transmission clock signal of a phase of 0° with which to synchronize data assigned to each lane when the logic of the data 18 is “1.”

Accordingly, because the synchronization circuit 98 is provided for each lane, it is possible to synchronize data assigned to the lane with the TX clock signal 13 independently for the lane when the result of sampling the data 17 with the data 16 is logical “0.” Likewise, because the synchronization circuit 98 is provided for each lane, it is possible to synchronize data assigned to the lane with the TX clock signal 14 independently for the lane when the result of sampling the data 17 with the data 16 is logical “1.”

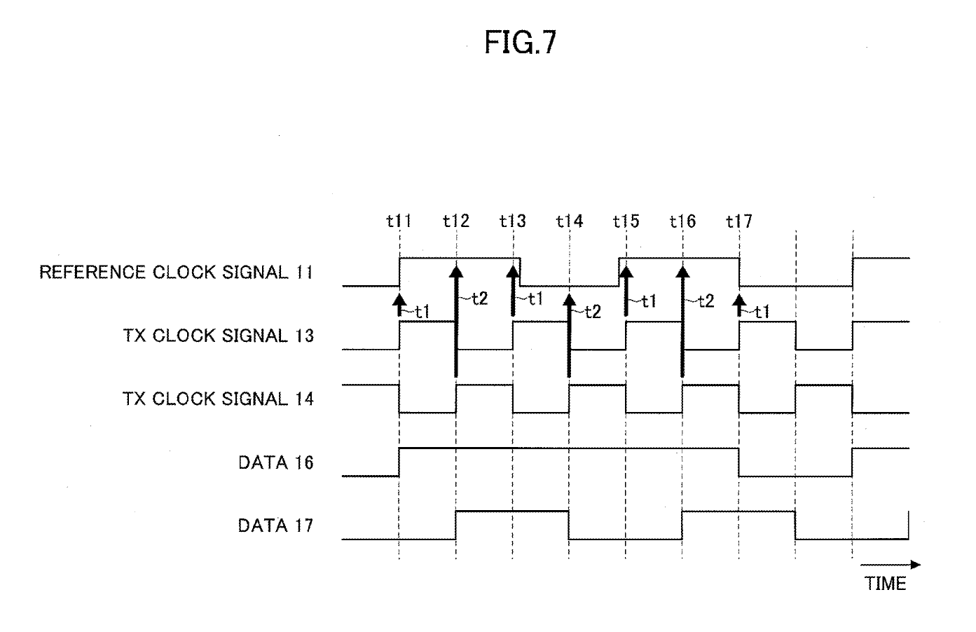

FIG. 7 also is a timing chart of signals that illustrates a phase adjustment operation of the first adjustment circuit 51. FIG. 7, however, illustrates a case where the rising edge of the reference clock signal 11 and the rising edge of the TX clock signal 13 are extremely close so that the rising edge of the TX clock signal 13 precedes and follows edges of the reference clock signal 11 because of the jitters of the reference clock signal 11 and the TX clock signal 13. In this case, as illustrated in FIG. 7, the data 16 irregularly change to a signal of a duty ratio different from 50%. In FIG. 7, because of jitters, the rising edge of the TX clock signal 13 at time t13 precedes a falling edge of the reference clock signal 11, and the rising edge of the TX clock signal 13 at time t15 follows a rising edge of the reference clock signal 11.

Accordingly, when the first detection circuit 96 detects that the duty ratio of the data 16 is not equal to 50%, the control circuit 95 controls the selector circuit 100 so that the TX clock signal 14 is selected as a transmission clock signal of a phase of 0° with which to synchronize data assigned to each lane. On the other hand, when the second detection circuit 97 detects that the duty ratio of the data 17 is not equal to 50%, the control circuit 95 controls the selector circuit 100 so that the TX clock signal 13 is selected as a transmission clock signal of a phase of 0° with which to synchronize data assigned to each lane.

Accordingly, because the synchronization circuit 98 is provided for each lane, it is possible to synchronize data assigned to the lane with the TX clock signal 13 independently for the lane when the second detection circuit 97 determines that the duty ratio of the data 17 is not equal to 50%. Likewise, because the synchronization circuit 98 is provided for each lane, it is possible to synchronize data assigned to the lane with the TX clock signal 14 independently for the lane when the first detection circuit 96 determines that the duty ratio of the data 16 is not equal to 50%.

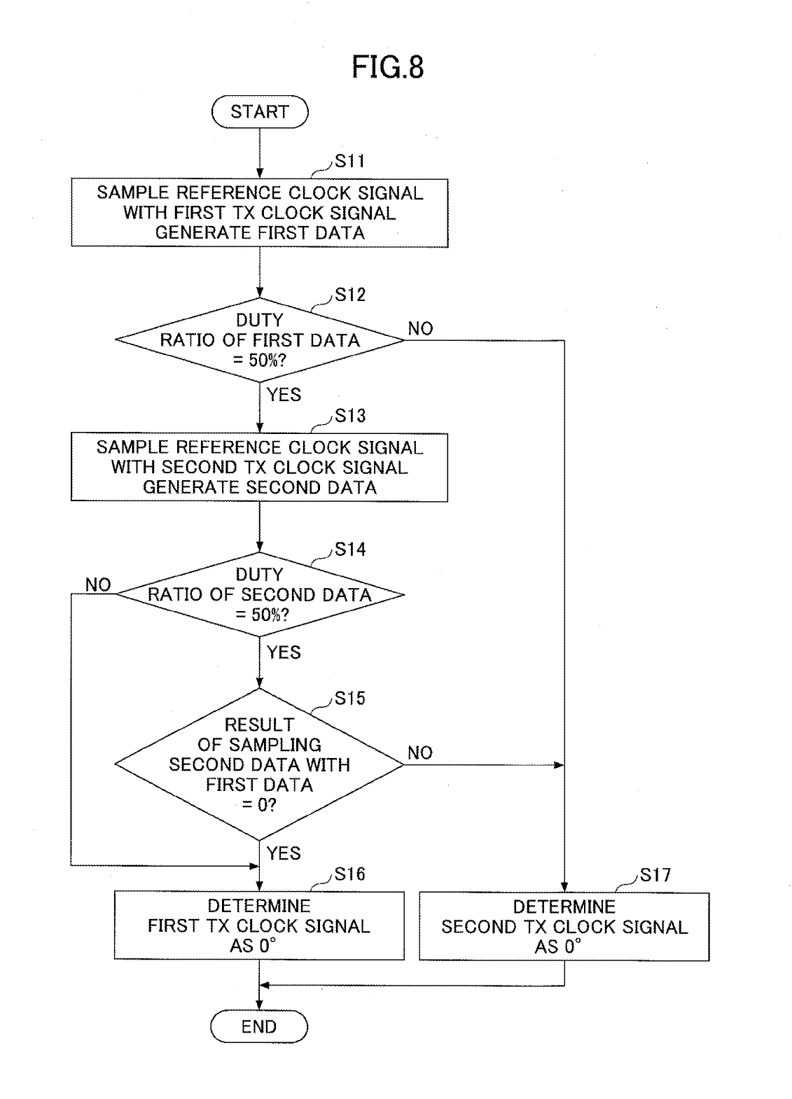

FIG. 8 is a flowchart illustrating a phase adjustment operation of the first adjustment circuit 51.

Referring to FIG. 8, at step S11, the first generation circuit 91 generates the data 16 (first data) by sampling the reference clock signal 11 with the TX clock signal 13 (first TX clock signal).

At step S12, the first detection circuit 96 determines whether the duty ratio of the data 16 is equal to 50%. If the duty ratio of the data 16 is other than 50% (NO at step S12), at step S17, the synchronization circuit 98 determines the TX clock signal 14 as a transmission clock signal of a phase of 0° with which to synchronize data assigned to each lane irrespective of the logical value of the data 18. On the other hand, if the duty ratio of the data 16 is equal to 50% (YES at step S12), at step S13, the first generation circuit 91 generates the data 17 (second data) by sampling the reference clock signal 11 with the TX clock signal 14 (second TX clock signal).

Next, at step S14, the second detection circuit 97 determines whether the duty ratio of the data 17 is equal to 50%. If the duty ratio of the data 17 is other than 50% (NO at step S14), at step S16, the synchronization circuit 98 determines the TX clock signal 13 as a transmission clock signal of a phase of 0° with which to synchronize data assigned to each lane irrespective of the logical value of the data 18. On the other hand, if the duty ratio of the data 17 is equal to 50% (YES at step S14), at step S15, the data comparator circuit 94 samples the data 16 with the data 17, and determines whether the sampled value is “0” or “1.” If the sampled value is “0,” the data comparator circuit 94 outputs the data 18 of logical “0.” If the sampled value is “1,” the data comparator circuit 94 outputs the data 18 of logical “1.”

If the logic of the data 18 is “0” at step S15, at step S16, the synchronization circuit 98 determines the TX clock signal 13 as a transmission clock signal of a phase of 0° with which to synchronize data assigned to each lane. On the other hand, if the logic of the data 18 is “1” at step S15, at step S17, the synchronization circuit 98 determines the TX clock signal 14 as a transmission clock signal of a phase of 0° with which to synchronize data assigned to each lane.

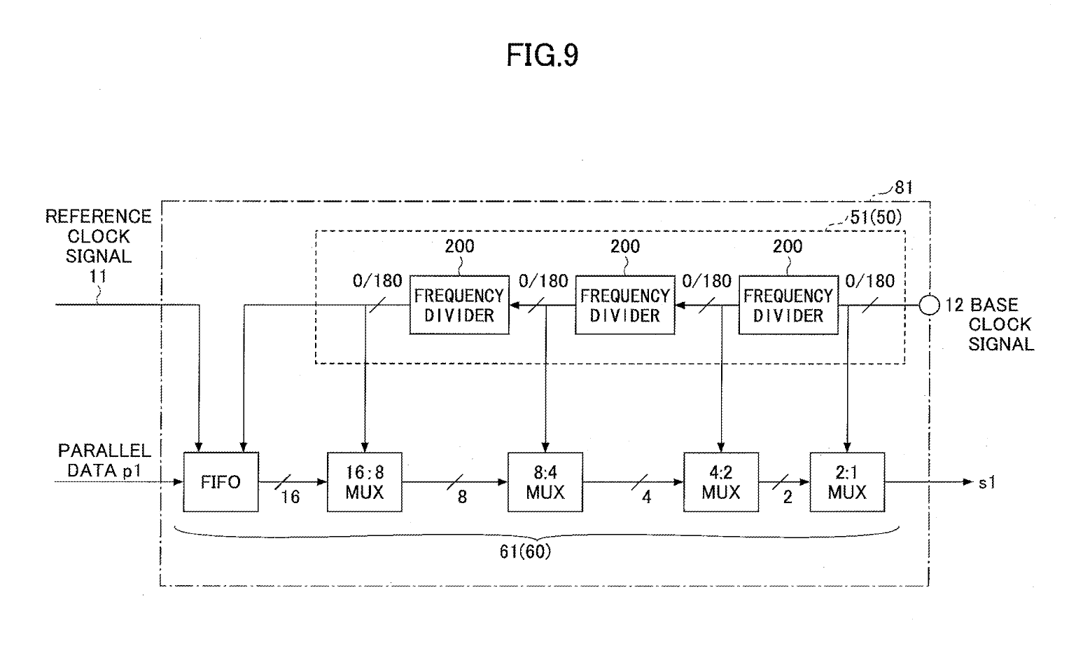

FIG. 9 is a diagram illustrating a configuration of the serializer 81 (FIG. 3) provided in the lane L1. The serializers provided one for each lane in the phase adjustment circuit 21 have the same function, and accordingly, a description is given taking the serializer 81 as a typical example.

In order to convert the parallel data p1 into the serial data s1 that are synchronized with a TX clock signal having a higher frequency than the reference clock signal 11, the serializer 81 includes, for example, frequency dividers 200 that divide the TX clock signals 13 and 14 into signals of one or more kinds of frequencies and output the signals. The transmission circuit 60 synchronizes parallel data assigned to each lane with one of the two transmission signals in antiphase subjected to frequency division in one of the frequency dividers 200, which one transmission signal has the smaller phase difference from the reference clock signal 11, and transmits the data on a lane-by-lane basis.

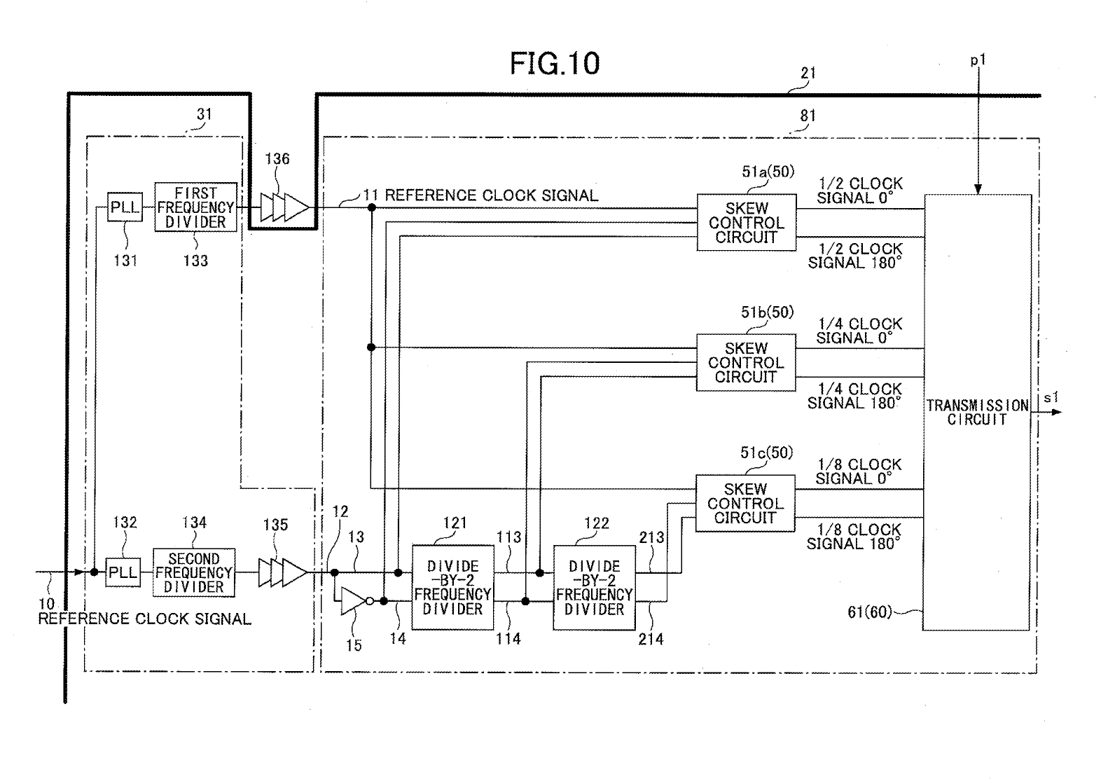

FIG. 10 is a diagram illustrating an example of the phase adjustment circuit 21. The PLL 31 is an example of a phase locked loop that generates the reference clock signal 11 and the base clock signal 12, which are different in division ratio from each other, based on the common reference clock 10.

The PLL 31 includes a first PLL 131 to which the reference clock signal 10 is input and a first frequency divider 133 that generates the reference clock signal 11 having a frequency obtained by dividing the output of the PLL 131 according to a first division ratio. The reference clock signal 11 is distributed to each lane, and skews in distributing the reference clock signal 11 to each lane are equalized by a delay circuit 136. The delay circuit 136, which is provided outside the phase adjustment circuit 21, is a circuit that adjusts time taken for transmitting the reference clock signal 11 to a lane so that the time is uniform among the lanes.

Furthermore, the PLL 31 includes a second PLL 132 to which the reference clock signal 10 is input and a second frequency divider 134 that generates the base clock signal 12 having a frequency obtained by dividing the output of the PLL 132 according to a second division ratio. The base clock signal 12 is distributed to each lane, and skews in distributing the base clock signal 12 to each lane are equalized by a delay circuit 135. The delay circuit 135, which is provided inside the phase adjustment circuit 21, is a circuit that adjusts time taken for transmitting the base clock signal 12 to a lane so that the time is uniform among the lanes.

The phases of the reference clock signal 11 and the base clock signal 12 generated by different PLLs and frequency dividers are uncorrelated.

The serializer 81 of the phase adjustment circuit 21 includes two frequency dividers 121 and 122. The frequency divider 121 outputs TX clock signals 113 and 114 obtained by dividing the frequencies of the TX clock signals 13 and 14 by two, respectively. The frequency divider 122 outputs TX clock signals 213 and 214 obtained by dividing the frequencies of the TX clock signals 113 and 114 by two, respectively.

Furthermore, the serializer 80 of the phase adjustment circuit 21 includes adjustment circuits 51a, 51b and 51c. Each of the adjustment circuits 51a, 51b and 51c has the same function as the first adjustment circuit 51 illustrated in FIG. 4.

The adjustment circuit 51a compares the reference clock signal 11 and the TX clock signals 13 and 14 and synchronizes data assigned to each lane with one of the TX clock signals 13 and 14 which one has the smaller phase difference from the reference clock signal 11. The adjustment circuit 51b compares the reference clock signal 11 and the TX clock signals 113 and 114 and synchronizes data assigned to each lane with one of the TX clock signals 113 and 114 which one has the smaller phase difference from the reference clock signal 11. The adjustment circuit 51c compares the reference clock signal 11 and the TX clock signals 213 and 214 and synchronizes data assigned to each lane with one of the TX clock signals 213 and 214 which one has the smaller phase difference from the reference clock signal 11.

As a result, it is possible to reduce skews among the clock signals output from the adjustment circuits 51a, 51b and 51c. Other lanes may have the same configuration as illustrated in FIG. 10.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. A phase adjustment circuit and method and a data transmission apparatus and system have been described in detail based on one or more embodiments of the present invention. It should be understood, however, that the various changes, substitutions, and alterations could be made hereto without departing from the spirit and scope of the invention.

What is claimed is:

1. A phase adjustment circuit, comprising:
a comparator circuit that compares, with respect to each of a plurality of lanes, a common reference clock signal fed to each of the lanes with first and second transmission clock signals each of which is in antiphase and is generated in each of the lanes; and
a synchronization circuit that synchronizes, with respect to each of the lanes, data distributed to each of the lanes with one of the first and second transmission clock signals, wherein a phase difference between the one of the first and second transmission clock signals and the reference clock signal is smaller than a phase difference between the other of the first and second transmission clock signals and the reference clock signal.

2. The phase adjustment circuit as claimed in claim 1,
wherein the comparator circuit includes
a first generation circuit that generates first data by sampling the reference clock signal with a first one of the first and second transmission clock signals; and
a second generation circuit that generates second data by sampling the reference clock signal with a second one of the first and second transmission clock signals, and
wherein the synchronization circuit synchronizes the data distributed to each of the lanes with the first one of the first and second transmission clock signals with respect to each of the lanes when a logic of sampling the second data with the first data is a first logic, and the synchronization circuit synchronizes the data distributed to each of the lanes with the second one of the first and second transmission clock signals with respect to each of the lanes when the logic of sampling the second data with the first data is a second logic.

3. The phase adjustment circuit as claimed in claim 2,
wherein the synchronization circuit synchronizes the data distributed to each of the lanes with the second one of the first and second transmission clock signals with respect to each of the lanes when the first data do not match a predetermined duty ratio, and the synchronization circuit synchronizes the data distributed to each of the lanes with the first one of the first and second transmission clock signals with respect to each of the lanes when the second data do not match the predetermined duty ratio.

4. The phase adjustment circuit as claimed in claim 1, further comprising:
a frequency divider that divides each of the first and second transmission clock signals into one or more kinds of frequencies and outputs transmission clock signals of the one or more kinds of frequencies,
wherein the comparator circuit compares the reference clock signal and the transmission clock signals output from the frequency divider, and
wherein the synchronization circuit synchronizes the data distributed to each of the lanes with one of the transmission clock signals output from the frequency divider, wherein a phase difference between the one of the transmission clock signals and the reference clock signal is smaller than a phase difference between the other of the transmission clock signals and the reference clock signal.

5. The phase adjustment circuit as claimed in claim 1, further comprising:
a phase locked loop that feeds the reference clock signal and a base clock signal for generating the first and second transmission clock signals to each of the lanes.

6. A data transmission apparatus, comprising:
a distribution circuit that distributes data to each of a plurality of lanes;
a comparator circuit that compares, with respect to each of the lanes, a common reference clock signal fed to each of the lanes and first with second transmission clock signals each of which is in antiphase and is generated in each of the lanes; and
a synchronization circuit that synchronizes, with respect to each of the lanes, the data distributed to each of the lanes by the distribution circuit with one of the first and second transmission clock signals, wherein a phase difference between the one of the first and second transmission clock signals and the reference clock signal is smaller than a phase difference between the other of the first and second transmission clock signals and the reference clock signal.

7. A data transmission system, comprising:
the data transmission apparatus as set forth in claim 6; and
a receiver that receives the data synchronized with the one of the first and second transmission clock signals by the synchronization circuit.

8. A phase adjustment method, comprising:
comparing, with respect to each of a plurality of lanes, a common reference clock signal fed to each of the lanes with first and second transmission clock signals each of which is in antiphase and is generated in each of the lanes; and
synchronizing, with respect to each of the lanes, data distributed to each of the lanes with one of the first and second transmission clock signals, wherein a phase difference between the one of the first and second transmission clock signals and the reference clock signal is smaller than a phase difference between the other of the first and second transmission clock signals and the reference clock signal.
